(19) United States
(12) Patent Application Publication
(10) Pub. No.: US 2017/0120694 A1
(43) Pub. Date: May 4, 2017

(54) TIRE WITH PUNCTURE-PROOF SPARE TIRE STRUCTURE

(71) Applicant: SHUT CHEN HSU, YILAN COUNTY (TW)

(72) Inventor: SHUT CHEN HSU, YILAN COUNTY (TW)

(21) Appl. No.: 14/932,519

(22) Filed: Nov. 4, 2015

(51) Int. Cl. B60C 17/04

(52) U.S. Cl. CPC B60C 17/047

(57) ABSTRACT

A tire with puncture-proof spare tire structure is provided. The structure forms a spare tire assembly that can be assembled rapidly and adapted to various tire types by being finely tuned. A tire using the spare tire structure is puncture-proof such that when punctured by sharp articles or knifes, the tire can still work to make safe arrival at a nearby repair workshop. This saves a car driver who has a damaged tire from the trouble of shoving the car and from the danger of endangering his/her life, in turn ensuring the public traffic safety.

### BACKGROUND OF THE INVENTION

1. Technical Field

The present invention relates to a tire with a puncture-proof spare tire structure, which can be rapidly assembled and is adaptive to various tire types by using fine tuning, thereby ensuring driving safety.

2. Description of Related Art

Generally, tires can be categorized into regular tires that have an inner tube therein and tubeless tires without using an inner tube, both of which are not resistant to damages caused by external force. A tire with an inner tube is ready to work when the inner tube is inflated to expand an outer tube of the tire. Upon puncture by a knife or a sharp article, the tire becomes flat and unusable immediately, bringing the driver with much trouble, such as shoving the car. In the case such a tire gets punctured when the car using it is running fast, traffic accidents are likely to happen. On the other hand, tubeless tires are known to be able to defer the tire's complete flatness upon puncture, so as to provide sufficient buffer time for the driver to drive the car to a nearby repair workshop. While this buffering function does allow a driver with a damaged tubeless tire to safely arrive at a repair workshop, this function can also hinder a car driver from immediately noticing the tire damage as the tire pressure does not drop sharply. In this case, if the car driver is not aware of the tire damage drives his/her car in high speed or on a rugged road, the tire is likely to become unusable immediately and put the driver into the risk of a traffic accident that endangers his/her life.

In view of the shortcomings of the prior-art devices, the present inventor is concerned about the public traffic safety and has invented numerous novel tire improvements, including many that have been patented in many countries. Nevertheless, instead of being complacent about his achievements, the inventor continues to research and improve his patented inventions (as the inventor owns numerous applications and patents, the list is too long to be exhaustively named herein), and herein provides a further improved simplified structure that can be assembled rapidly in order to benefit the public in terms of driving safety.

The configuration, objectives, means and spirit of the present invention will be explained in detail in the following paragraphs and the accompanying drawing.

### SUMMARY OF THE INVENTION

The present invention is directed to a tire with a puncture-proof spare tire structure. Particularly, the structure can be installed to a tire rapidly and is applicable to various tire types by using fine tuning. The spare tire structure makes the tire using the same puncture-proof. The tire has its two top inner edges formed with hooked portions for engaging with a spare tire body. Thereby the spare tire structure can be engaged with the hooked portions of the tire rapidly and arm the tire with puncture-proof ability.

The objective of the present invention is to provide such a puncture-proof structure, wherein the preassembled spare tire body is a C-shaped part that can be directly engaged with the hooked portions of the tire, thereby achieving rapid installation. Besides, a tire using the spare tire body is puncture-proof such that when punctured by sharp articles or knifes, the tire can still work to make safe arrival at a nearby repair workshop. This saves a car driver who has a flat tire from shoving the car along a high-traffic road and risking his/her life, thereby ensuring the public traffic safety.

The spare tire structure includes a spare tire body that is a C-shaped member and has its inner circular surface formed with a groove. The spare tire body also has locking blocks and ribs. The locking block has its top formed with a ridge. Each of the locking blocks has a locking hole. The first and last locking blocks each has a through hole. The spare tire body is a C-shaped member with its front and rear ends each provided with a combining block. The two combining blocks have threaded holes communicated with each other. The two combining blocks each have one lateral formed with a through hole.

The groove of the spare tire body of the spare tire structure has plural pairs of retaining holes for fittingly receiving the hooks of the V-shaped braces, so as to structurally strengthen the groove. Therein each of the retaining holes is an L-shaped hole.

The through holes of the first and last locking blocks of the spare tire body of the spare tire structure are fore a first brace seat and a second brace seat to assemble, respectively. The locking holes of the other locking blocks of the spare tire body are for a plurality of linking plates to assemble and thereby forming a string to structurally strengthen the spare tire body.

The spare tire body is a C-shaped member having its inner circular surface formed with a groove that is configured to engage with the hooked portions at the inner surface of the tire. With additional fastening components, the components can be assembled rapidly and firmly. When the tire is flat, the spare tire structure allows the tire to make safe arrival at a nearby repair workshop.

### BRIEF DESCRIPTION OF THE DRAWINGS

FIG. 1 is a cutaway view of a tire according to the present invention without the puncture-proof spare tire structure assembled thereto;

FIG. 2 is a perspective view of a spare tire body of the puncture-proof spare tire structure of the present invention;

FIG. 2A is a cutaway view of the spare tire body;

FIG. 2B is a cutaway view of the spare tire body cut along Line A-A of FIG. 2;

FIG. 3 is an exploded view of the puncture-proof spare tire structure;

FIG. 4 is a perspective view of a V-shaped brace of the present invention;

FIG. 5 is a perspective view of a first brace seat of the present invention;

FIG. 6 is a perspective view of a second brace seat of the present invention;

FIG. 7 is a perspective view of a pressing shaft of the present invention;

FIG. 8 is a perspective view of a threaded pressing shaft of the present invention;

FIG. 9 is a perspective view of the spare tire structure of the present invention;

FIG. 10 is a cutaway view of the spare tire structure cut along Line B-B of FIG. 9;

FIG. 11 shows the tire assembled with the spare tire structure; and

FIG. 12 is a schematic drawing showing the spare tire structure in a flat tire.

### DETAILED DESCRIPTION OF THE INVENTION

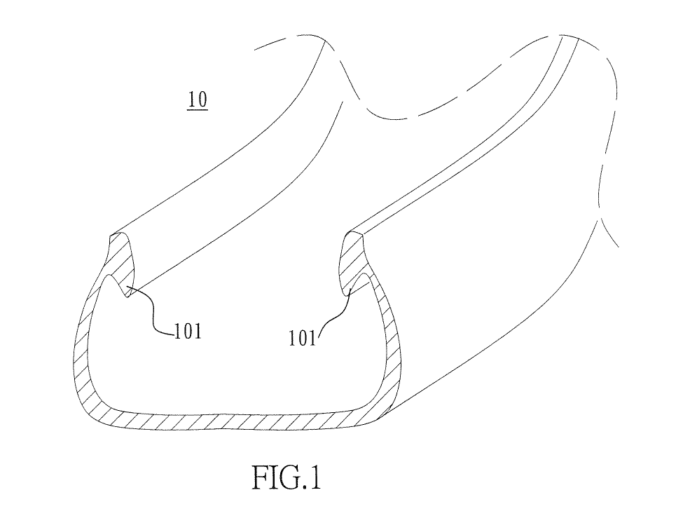

FIG. 1 according to the present invention shows a tire that is to be assembled with a puncture-proof spare tire structure. As shown, the tire 10 has its two top inner edges formed with hooked portions 101 and is reinforced by cords arranged therein.

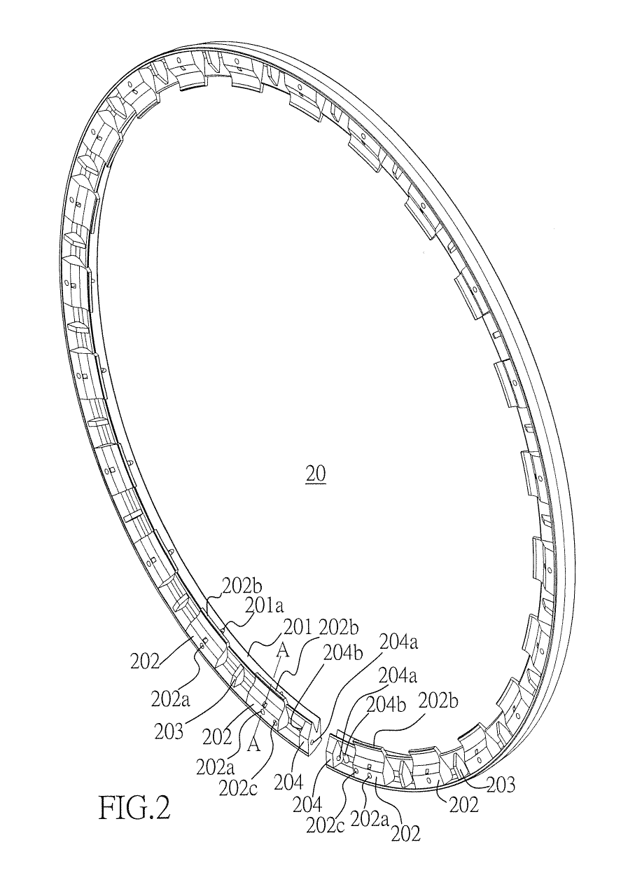

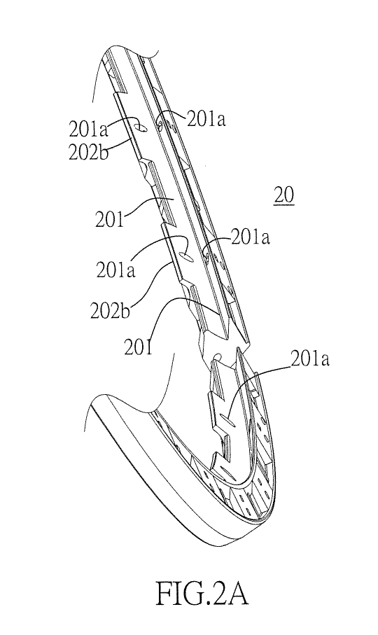

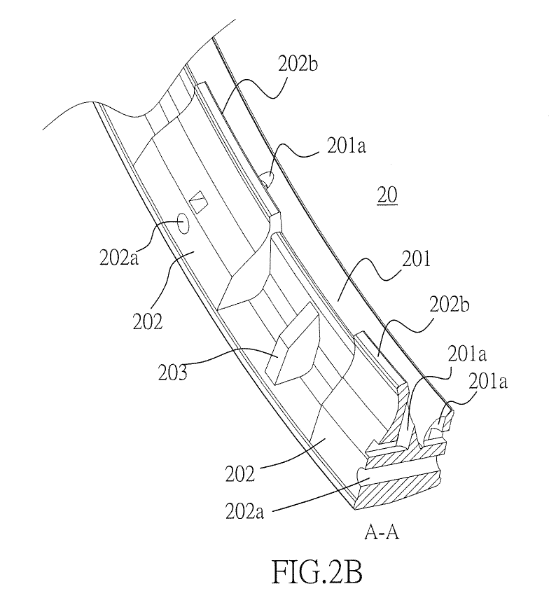

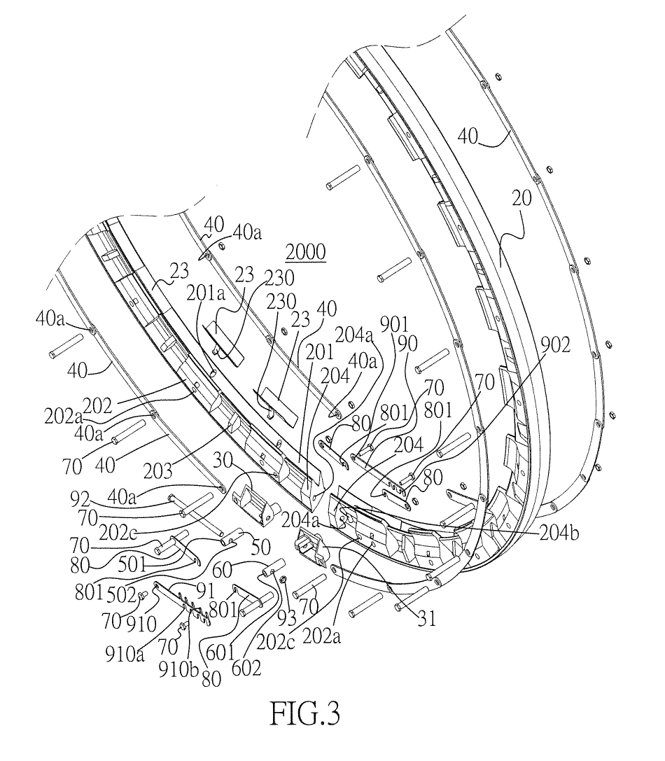

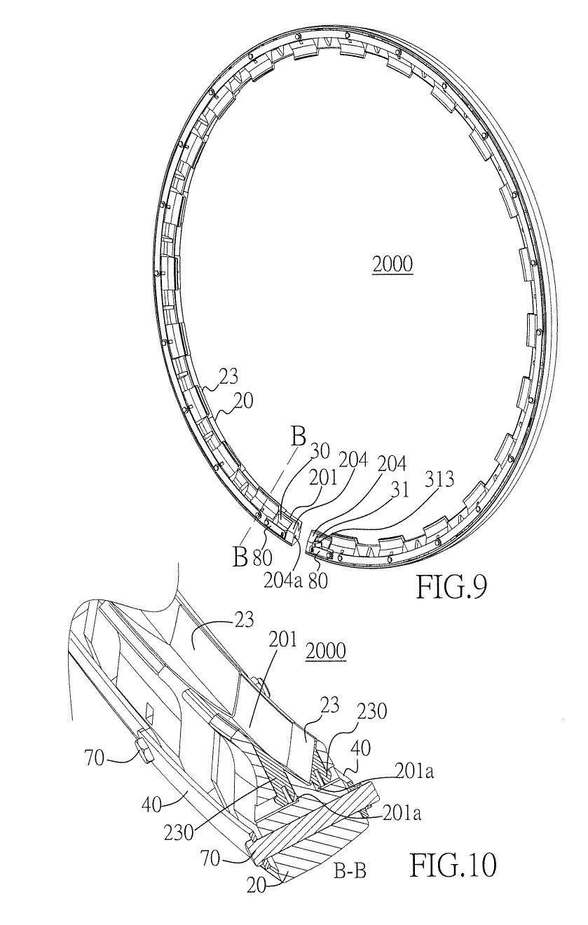

FIG. 3 is an exploded view of the puncture-proof spare tire structure. As shown, spare tire structure 2000 includes a spare tire body 20, (FIG. 2, FIG. 2A, FIG. 2B, FIG. 9) that is a C-shaped member with its inner circular surface formed with a groove 201, and plural raised locking blocks 202 and ribs 203 of the spare tire body 20. Each of the locking blocks 202 has its top surface formed with a ridge 202b and includes a locking hole 202a. Furthermore, the first and last locking block 202 are each additionally provided with a through hole 202c.

Therein, the locking hole 202a of the locking block 202 of the spare tire body 20 is configured to allowing a screw 70 passing through threaded holes 40a formed on corresponding linking plates 40 to be screwed therein, so as to connect the linking plates 40 and attach the string of linking plates 40 to each of two laterals of the spare tire body 20, thereby structurally strengthening the spare tire body 20.

The groove 201 of the spare tire body 20, as shown in FIG. 2B, and FIG. 10, is provided with plural pairs of retaining holes 201a for engaging with hooks 230 of plural V-shaped braces 23.

Moreover, the spare tire body 20 is a C-shaped member whose front and rear ends are each provided with a combining block 204 that has a threaded hole 204a. The threaded holes 204a of the two combining blocks 204 are communicated with each other. Also, each of the two combining blocks has its one lateral formed with a through hole 204b.

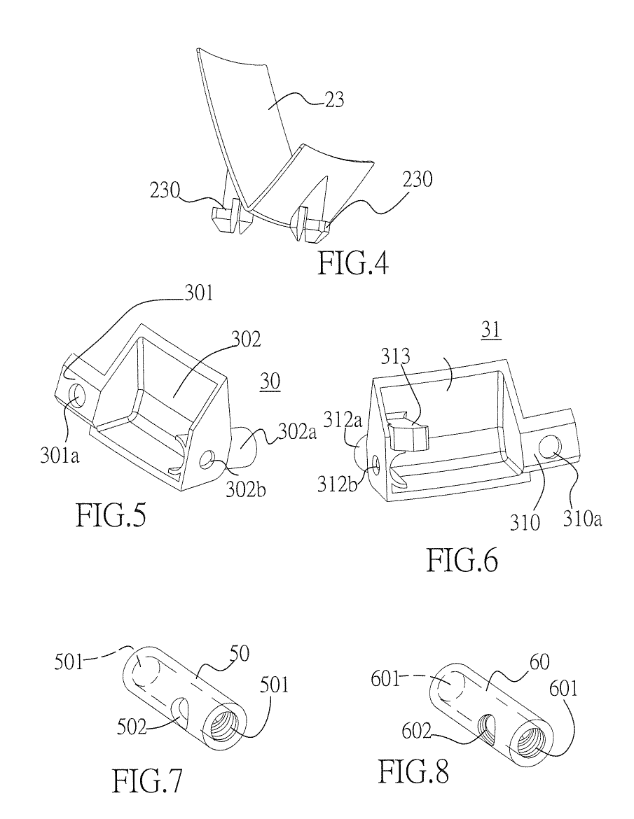

Each of the V-shaped brace 23, as shown in FIG. 4 has its lower part formed with two hooks 230, as shown in FIG. 10 clearly. The hooks 230 are inserted and engaged with the retaining holes 201a of the groove 201 of the spare tire body 20, so as to hold the V-shaped brace 23 in the groove 201 in position.

A first brace seat 30, as shown in FIG. 5, has a locking plate 301 on which a through hole 301a is formed. A support 302 extends laterally from the locking plate 301. A tube 302a extends from the support 302. The tube 302a has a through hole 302b that runs radially therethrough and stops at the lateral wall of the support 302. Referring also to FIG. 3 and FIG. 9, by aligning the through hole 301a of the locking plate 301 with the through hole 202c of the first locking block 202 of the spare tire body 20, the tube 302a of the first brace seat 30 can be inserted into the through hole 204b of the spare tire body 20, and then a screw 70 passing through a pivot hole of a hasp 80, the through hole 301a of the locking plate 301, and the through hole 202c of the first locking block 202 of the spare tire body 20 can be fixed at a pivot hole of another hasp 80.

A second brace seat 31, as shown in FIG. 6, has a locking plate 310 on which a through hole 310a is formed. A support 312 extends laterally from the locking plate 310. A tube 312a extends from the support 312. The tube 312a has a through hole 312b that runs radially therethrough and stops at the lateral wall of the support 312. A hook body 313 projects from the upper part of the tube 312a. Referring also to FIG. 3 and FIG. 9, by aligning the through hole 310a of the locking plate 310 with the through hole 202c of the last locking block 202 of the spare tire body 20, the tube 302a of the second brace seat 31 can be inserted into the through hole 204b of the spare tire body 20, and then a screw 70 passing through a pivot hole of a hasp 80, the through hole 310a of the locking plate 310, and the through hole 202c of the last locking block 202 of the spare tire body 20 can be fixed at a pivot hole of another hasp 80.

Therein, as shown in FIG. 3, FIG. 9 and FIG. 10, the first brace seat 30, the second brace seat 31 and the linking plates 40 are combined with the spare tire body 20, so as to enhance the supporting strength of the spare tire body 20.

A pressing shaft 7, as shown in FIG. 7, is an axle that has its two ends formed with threaded holes 501, and has a through hole 702 running radially therethrough. The pressing shaft 7 is received in the tube 302a of the first brace seat 30.

A pressing bolt 60, as shown in FIG. 8, is an axle that has its two ends formed with threaded holes 601, and has a threaded retaining hole 602 running radially therethrough. The pressing bolt 60 is received in the tube 312a of the second brace seat 31.

A hasp 80, as shown in FIG. 3, is provided as a piece with its one end having a pivot hole and an opposite end having a notch 801.

A stringing plate 90, as shown in FIG. 3, is provided as a piece with its one end having a pivot hole 901 and an opposite end having a plurality of notches 902 for selective use.

A stringing hasp 91, as shown in FIG. 3, is provided as a piece with its one end having a pivot hole 901 and an opposite end having a plurality of notches 910a and a plurality of posts 910b.

There are also a pressing screw bolt 92 and a check nut 93, as shown in FIG. 3.

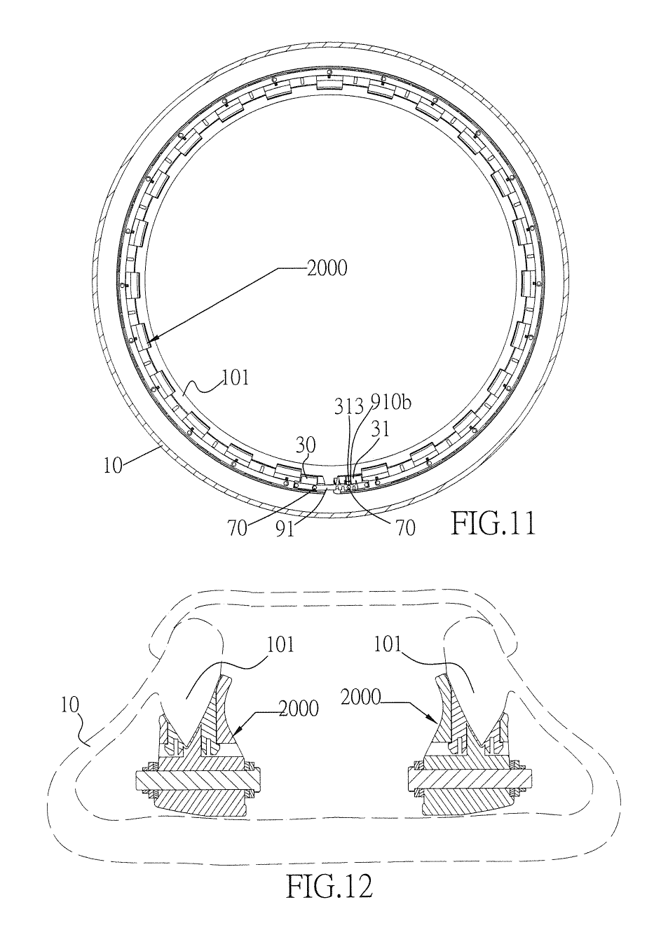

Referring to FIGS. 3, 9 and 10, after the groove 201 of the spare tire body 20 of the spare tire structure 2000 and the V-shaped braces 23 are combined with the hooked portion 101 of the tire 10, as shown in FIGS. 11 and 12, a pressing screw bolt 92 (as shown in FIGS. 5 and 7) is inserted into the through hole 302b of the tube 302a of the first brace seat 30, the through hole 502 of the pressing shaft 50, the threaded holes 204a of the combining blocks 204 at two ends of the spare tire body 20, and then the through hole 312b of the tube 312a of the second brace seat 31 (as shown in FIGS. 6 and 8), and finally screwed into the threaded retaining hole 602 of the threaded pressing shaft 60, so as to combine the spare tire body 20 and the hooked portion 101 of the tire 10 tightly. Afterward, a check nut 99 is screwed into the end of the pressing screw bolt 902 to prevent looseness and ensure firm combination. The pivot hole 901 and the notch 902 of the stringing plate 90 are aligned with the notch 801 of the hasp 80 and the threaded holes 501, 601 of the pressing shaft 50 and the threaded pressing shaft 60. Then a screw 70 is used to fasten them. The pivot hole 910 and the notch 910a of the stringing hasp 91 are aligned with the threaded holes 501, 601 of the pressing shaft 50 and the threaded pressing shaft 60. Before a screw is screwed to fasten these components, the notch 801 of the hasp 80 locked to the first brace seat 30 and the second brace seat 31 is engaged with the screw so that when the screw is screwed to the end, everything is held in position. Referring to FIG. 11, the posts 910b of the stringing hasp 91 at this time abut against the hook body 313 of the second brace seat 31, thereby further ensuring firm combination between the spare tire structure 2000 and the hooked portion 101 of the tire 10. Referring to FIG. 12, when the tire 10 is punctured by sharp articles, the spare tire structure 2000 allows the tire to make safe arrival at a nearby repair workshop.

What is claimed is:

1. A tire with a puncture-proof spare tire structure, comprising:
the tire, having two top inner edges thereof formed with hooked portions and being reinforced by cords arranged therein;
the spare tire structure, including a spare tire body that is a C-shaped member with inner circular surface thereof formed with a groove, and plural raised locking blocks and ribs, each of the locking blocks having a top surface formed with a ridge and including a locking hole, and the first and last locking block being each additionally provided with a through hole;
the locking hole of the locking block of the spare tire body being configured to allowing a screw passing through threaded holes formed on corresponding linking plates to be screwed therein, so as to connect the linking plates and attach the string of linking plates to each of two laterals of the spare tire body, thereby structurally strengthening the spare tire body;
the groove of the spare tire body being provided with plural pairs of retaining holes for engaging with hooks of plural V-shaped braces;
the spare tire body being a C-shaped member whose front and rear ends are each provided with a combining block that has a threaded hole, the threaded holes of the two combining blocks being communicated with each other, each of the two combining blocks having one lateral thereof formed with a through hole;
each of the V-shaped brace having a lower part thereof formed with two hooks, the hooks being inserted and engaged with the retaining holes of the groove of the spare tire body, so as to hold the V-shaped brace in the groove in position;
a first brace seat having a locking plate on which a through hole is formed, a support extending laterally from the locking plate, a tube extending from the support, the tube having a through hole that runs radially therethrough and stops at a lateral wall of the support, wherein by aligning the through hole of the locking plate with the through hole of the first locking block of the spare tire body, the tube of the first brace seat is allowed to be inserted into the through hole of the spare tire body, and then a screw passing through a pivot hole of a hasp, the through hole of the locking plate, and the through hole of the first locking block of the spare tire body is allowed to be fixed at a pivot hole of another hasp;
a second brace seat having a locking plate on which a through hole is formed, a support extending laterally from the locking plate, a tube extending from the support, the tube having a through hole that runs radially therethrough and stops at a lateral wall of the support, a hook body projecting from an upper part of the tube, wherein by aligning the through hole of the locking plate with the through hole of the last locking block of the spare tire body, the tube of the second brace seat is allowed to be inserted into the through hole of the spare tire body, and then a screw passing through a pivot hole of a hasp, the through hole of the locking plate, and the through hole of the last locking block of the spare tire body is allowed to be fixed at a pivot hole of another hasp;
a pressing shaft being an axle that has two ends thereof formed with threaded holes, and has a through hole running radially therethrough, the pressing shaft being received in the tube of the first brace seat;
a pressing bolt being an axle that has two ends thereof formed with threaded holes, and has a threaded retaining hole running radially therethrough, the pressing bolt being received in the tube of the second brace seat;
a hasp being provided as a piece with one end thereof having a pivot hole and an opposite end thereof having a notch;
a stringing plate being provided as a piece with one end thereof having a pivot hole and an opposite end thereof having a plurality of notches for selective use;
a stringing hasp being provided as a piece with one end thereof having a pivot hole and an opposite end thereof having a plurality of notches and a plurality of posts;
a pressing screw bolt and a check nut;
wherein after the groove of the spare tire body of the spare tire structure and the V-shaped braces are combined with the hooked portions of the tire, a pressing screw bolt is inserted into the through hole of the tube of the first brace seat, the through hole of the pressing shaft, the threaded holes of the combining blocks at two ends of the spare tire body, and then the through hole of the tube of the second brace seat, and finally screwed into the threaded retaining hole of the threaded pressing shaft, so as to combine the spare tire body and the hooked portions of the tire tightly, and afterward, the check nut is screwed into the end of the pressing screw bolt to prevent looseness and ensure firm combination, the pivot hole and the notch of the stringing plate being aligned with the notch of the hasp and the threaded holes of the pressing shaft and the threaded pressing shaft, then a screw for fastening, the pivot hole and the notch of the stringing hasp being aligned with the threaded holes of the pressing shaft and the threaded pressing shaft, before a screw is screwed deep in, the notch of the hasp locked to the first brace seat and the second brace seat being engaged with the screw so that when the screw is screwed to the end, everything is held in position, at this time the posts of the stringing hasp abutting against the hook body of the second brace seat, thereby further ensuring firm combination between the spare tire structure and the hooked portions of the tire.
